(19) United States
(12) Patent Application Publication
(10) Pub. No.: US 2008/0206720 A1
(43) Pub. Date: Aug. 28, 2008

(54) Immersive video projection system and associated video image rendering system for a virtual reality simulator

(76) Inventor: Stephen E. Nelson, Munroe Falls, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/712,020

(22) Filed: Feb. 28, 2007

(51) Int. Cl. G09B 9/02

(52) U.S. Cl. 434/44

(57) ABSTRACT

An immersive video projection system for a virtual reality simulator includes a plurality of imaging units each configured to project a video image upon a plurality of respective first surface mirrors. The video images reflected off of each of the first surface mirrors are then incident upon a panoramic display having a radius of curvature that matches the radius of curvature of the first surface mirrors, so as to provide a high-fidelity image with reduced artifacts for use in simulating motion of various activities. The immersive video projection system may also utilize an interface system that is configured to provide highly realistic control arrangements that provide realistic levels of feedback thereto, so as to impart a highly realistic and immersive experience to the user of the virtual reality simulator.

### TECHNICAL FIELD

Generally, the present invention relates to a video projection system. Particularly, the present invention relates to an immersive video projection system that utilizes a panoramic projection screen upon which computer generated video images are presented. Particularly, the present invention relates to a video projection system for a virtual reality simulator that utilizes multiple imaging units and a plurality of corresponding convex first surface mirrors for rendering immersive video images upon a hemispherical panoramic screen.

### BACKGROUND

Virtual reality simulators including, motion simulators, relate generally to electronic systems that are configured to create interactive virtual environments that are realistic and immersive. These virtual environments are generally configured to allow a participant to engage in various activities, such as flying, without being subjected to the risks associated with actually engaging in the activity. In order to create a realistic environment, virtual reality simulators rely upon various combinations of mock-up structures, audio, video, and physical feedback systems. Although simulation technologies exist to create an immersive experience, virtual reality simulators vary widely in their ability to accurately and realistically capture the details and nuances of the activity being simulated.

Flight simulation is one type of simulator that depends upon an accurate and realistic environment, as it is used as a tool to teach a user how to control an aircraft. In fact, in some circumstances a flight student is required to spend a predetermined number of hours in the flight simulator before flying an actual aircraft. Moreover, such a simulator is beneficial as it allows him or her to gain endless hours of flight time without the risk of injury to the flight student or other user of the simulator, as there would be in flying an actual aircraft. In addition, because of the increasing costs of fuel, maintenance, storage, and insurance of an actual aircraft, flight simulation provides a cost effective alternative for gaining additional flight experience, as well as keeping an existing pilot's skills and understanding current with respect to the most recent FAA (Federal Aviation Administration) regulations. As such, flight simulators provide a convenient and cost effective alternative for those who desire to fly.

Because, the purpose of a flight simulator is to teach a flight student, or to allow pilots to maintain their skills, it is a goal of flight simulation systems to duplicate as accurately as possible every facet of the actual aircraft, including the appearance and arrangement of the instrumentation and control systems within the cockpit, the physical sounds and vibrations generated by the aircraft, as well as the appearance of the computer generated virtual environments, such as an aerial view of sky and ground terrain, in which the aircraft is being navigated. In other words, flight simulators generally attempt to provide the same “look and feel” as is provided by an actual aircraft. Thus, by accurately replicating the experience of controlling an aircraft, the flight simulator is able to provide a robust environment for the flight student, or pilot, allowing him or her to seamlessly transfer the skills acquired from the simulated environment over to the operation of an actual aircraft, which is desirable.

Unfortunately, the level of realism provided by a flight simulator is generally dictated by its cost, with high-cost simulators providing the highest level of realism, and low-cost simulators providing the lowest level of realism and immersion. As such, low-cost flight simulators generally provide inaccurate cockpit instrumentation and control arrangements as compared to that of an actual aircraft. In addition to the accuracy of the layout of the instrumentation and controls maintained by the simulator, low-cost flight simulators also use video and audio systems that typically provide low-quality visual and acoustic performance. For example, low-cost flight simulators may represent the center, left windows, and right windows of the cockpit of a plane or helicopter by corresponding individual LCD (liquid crystal display) video monitors. Whereas other low-cost flight simulators may not display the peripheral windows of the cockpit, and may choose to use only a single video monitor to represent the center window of the aircraft. Such a configuration unrealistically narrows the pilot's field of view, preventing the pilot from seeing important navigational beacons, and structures, such as the runway that are on the ground. In fact, pilots generally visually identify the location of the runway out of their side view windows when they are making their approach to land the aircraft. As such, low-cost simulators that fail to present the right and left side views do not allow the pilot or flight student to have the opportunity to utilize these views when making navigational decisions relating to the aircraft. Moreover, due the narrowed field of view provided by low-cost simulators, students are unable to effectively engage in pattern training, which is required by the FAA.

Some low-cost flight simulators utilize rear projection imaging systems to display the aerial view and ground terrain that is encountered by the simulated aircraft. These imaging systems typically utilize a video projection unit such as a DLP or LCD type projector, a reflecting mirror, and an imaging screen. Unfortunately, because of the position of the mock cockpit structure with respect to the imaging screen and the nature of video projectors, a “screen-door” effect may be apparent to the user of the simulator. Further, the reflecting mirrors used in low-cost simulators are typically comprised of glass having a reflective surface that is applied to its back surface. As such, the projected image delivered from the projection unit is required to pass through the glass twice before it is incident on the rear of the projection screen, thus resulting in an unwanted and distracting double image being generated on the imaging screen. In addition, the use of a back surfaced mirror generally results in a significant loss of light intensity, which results in the rendered images being displayed upon the imaging screen with reduced contrast and brightness.

Low-cost simulators also generally do not provide an accurate depth perception to the user as a result of the use of low grade imaging components. Moreover, the controls provided by low-cost simulators often provide an inaccurate feel and typically lack positive feedback to the user in terms of the amount of force needed to actuate the various controls, such as the control stick for example. Finally, low-cost flight simulators generally do not effectively impart movement to the cockpit so that the flight student feels the physical sensations associated with the movement of the aircraft as it is navigated through the virtual environment, such as, for example, the ambient vibration of the aircraft's engine.

The deficiencies indicated above generally result in distracting artifacts, which serve to lessen the level of realism and immersion experienced by the user of the simulator. While many of these limitations are overcome by more costly flight simulators, such simulators are significantly more expensive, and as such, are generally reserved only for military or other official use, and not for the general public.

While flight simulators tend to rely on a variety of audio and video technologies mounted and arranged in a physical mock structure. Video games represent a basic virtual reality simulator that is generally limited to those images that are rendered on a flat two-dimensional monitor. Thus, as the user moves his head, his line of sight is taken off of the image, thus taking the user out of the gaming environment and experience. Moreover, changes in ambient lighting and movements that are in the user's peripheral line of sight, detract from the level of realism and immersion that may be attained by the game.

In addition, there currently exists exercise equipment, such as in the case of jogging treadmills and devices that replicate the motion of down-hill or cross-country skiing that utilize one or more two-dimensional flat panel monitors with computer generated moving images so as to create a virtual environment, thus giving the user the impression that he or she is actually jogging in a park or skiing down a slope for example. However, because the system is limited to the use of flat two-dimensional monitors, the user's peripheral vision is typically subjected to distracting movements and changes in ambient light. As such, the user is generally taken out of the experience that the video monitors are attempting to create.

Therefore, there is a need for an immersive video projection system and associated video image rendering system that is low-cost. Moreover, there is a need for a low-cost immersive video projection system and associated video image rendering system that utilizes a panoramic screen to provide a highly realistic and interactive environment for entertainment activities, as well as for simulating various activities, including flight. Additionally, there is a need for a low-cost immersive video display and video image rendering system that utilizes a plurality of convex first surface mirrors and associated high-resolution projectors to display moving images upon a hemispherical panoramic screen. Still further, there is a need for a low-cost virtual reality simulator that utilizes various display overlays to provide realistic avionic instrumentation and control arrangements to provide the look and feel of a real aircraft.

### SUMMARY OF THE INVENTION

In light of the foregoing, it is a first aspect of the present invention to provide a virtual reality simulator, comprising a plurality of spaced imaging units that are configured to receive imaging signals that are each associated with a discrete segment of a complete image, said imaging units configured to project a projection image that comprises said imaging signal; a plurality of first surface mirrors configured with a convex reflective face configured to reflect said projection images from each said respective imaging units; and a screen having an imaging surface configured to receive said projection images reflected from said mirrors, so as to display said complete image.

It is another aspect of the present invention to provide a feedback system for a virtual reality simulator comprising a frame structure maintained by the virtual reality simulator; a control stick pivotally mounted to said frame structure, said control stick carrying an arm; a pivot arm pivotally mounted to said frame structure; an adjustable turnbuckle pivotally mounted between said arm and said pivot arm; and a pair of struts pivotally mounted between said pivot arm and said frame; wherein the movement of the control stick is dampened by the operation of said struts.

It is yet another aspect of the present invention to provide an apparatus for a virtual reality simulator comprising a touch sensitive display having an imaging surface for displaying one or more user selectable images for controlling the virtual reality simulator; a panel configured to cover said imaging surface, said panel comprising a plurality of apertures configured to be aligned with said images shown on said imaging surface; and at least one housing to maintain a control, said control configured to control said virtual reality simulator.

It is another aspect of the present invention to provide a virtual reality simulator comprising a projection system including a plurality of spaced imaging units; a video spanning component coupled to said imaging units, said spanning component configured to receive imaging signals that are associated with a complete image, said spanning component configured to divide the width dimension of said complete image into a number of image segments equal to the number of said imaging units, wherein each said imaging units generates a projection image of each said image segments; a plurality of first surface mirrors configured with a convex reflective face configured to reflect said projection images from each said respective imaging units; and a screen having an imaging surface configured to receive each of said projection images reflected from said mirrors, so as to display said complete image.

It is still another aspect of the present invention to provide a virtual reality simulator comprising a flexible-type display; a primary computer adapted to execute simulation software, said primary computer delivering simulation images based on said simulation software to said display; and an interface system coupled to said primary computer, said interface system enabling a user to interact with said simulation software, and wherein said display is arranged with respect to said interface system to provide about 180 degrees of viewing area.

### BRIEF DESCRIPTION OF THE DRAWINGS

These and other features and advantages of the present invention will become better understood with regard to the following description, appended claims, and accompanying drawings wherein:

FIGS. 1A-B comprise a block diagram of the video projection and image rendering system for a virtual reality simulator according to the concepts of the present invention;

FIG. 2 is an elevational view of a cockpit as it is arranged with regard to a panoramic screen according to the concepts of the present invention;

FIG. 3 is a perspective view of an actuator riser used for a home entertainment system according to the concepts of the present invention;

FIGS. 4A-B comprise a block diagram of another embodiment of the video projection and image rendering system, which utilizes a video spanning component to project images upon the screen according to the concepts of the present invention;

FIG. 5 is a top plan view of the video projection system showing the arrangement of the screen with regard to a plurality of convex mirrors and associated imaging units according to the concepts of the present invention;

FIG. 6 is a top plan view of the video projection system further showing the arrangement of the screen with regard to the cockpit according to the concepts of the present invention;

FIG. 7 is an elevational view of a representative section of the panoramic screen according to the concepts of the present invention;

FIG. 8 is an elevational view of the panoramic screen that is configured such that its vertical midpoint is below the eye level of the user according to the concepts of the present invention;

FIG. 9 is an elevational view of the panoramic screen that is configured such that its vertical midpoint is at the eye level of the user according to the concepts of the present invention;

FIG. 10 is a perspective view of a display overlay having a plurality of apertures configured to align with various graphically rendered controls and gauges provided by a touch screen display provided by the cockpit according to the concepts of the present invention;

FIG. 11 is an elevational view of the display overlay showing its manner of attachment to the touch screen display according to the concepts of the present invention; and

FIG. 12 is an elevational view of a control stick maintained by the cockpit that is configured to actuate a precision potentiometer and a pair of associated gas-charged struts so as to impart a realistic amount of feedback to the movement of the control stick according to the concepts of the present invention.

### BEST MODE FOR CARRYING OUT THE INVENTION

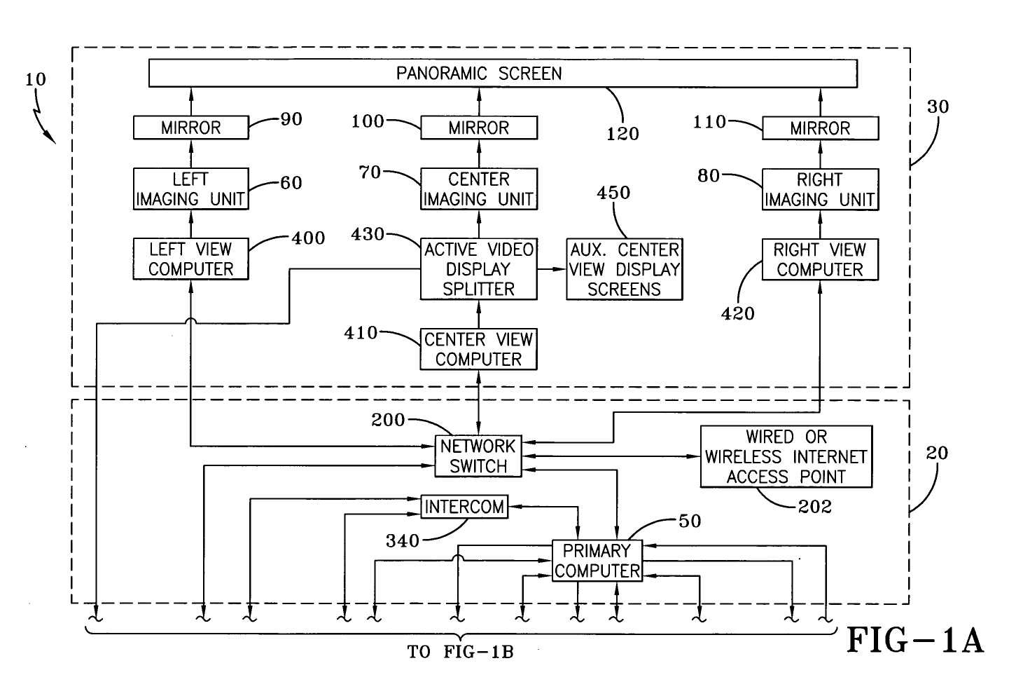

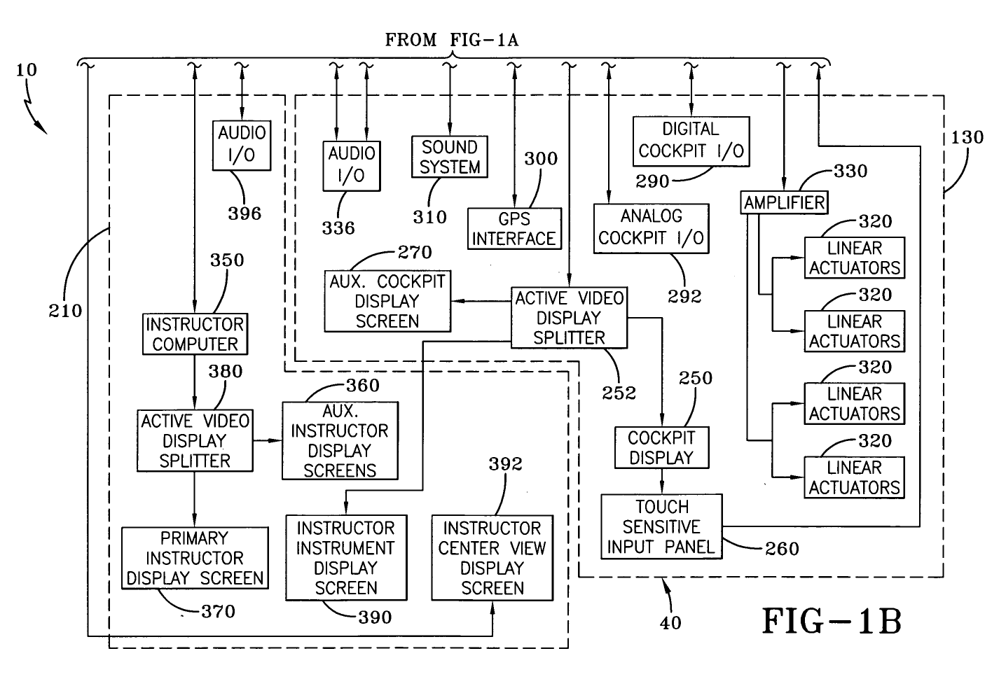

An immersive video projection and image rendering system for a virtual reality simulator is generally referred to by the numeral 10, as shown in FIGS. 1A-B of the drawings. The virtual reality simulator 10 generally comprises an image rendering system 20, a projection system 30, and a user interface 40. The image rendering system 20 comprises a computer network that includes a primary computer 50 that is configured to supply imaging signals generated by various simulation software, which are supplied to the projection system 30. For example, the simulation software may be configured to render imaging signals that create realistic and interactive moving virtual environments. Such environments are typically indicative of the particular simulation being rendered. In the case of flight simulation, the environments may comprise aerial views of the sky and ground terrain. The projection system 30 maintains a left imaging unit 60, a center imaging unit 70, and a right imaging unit 80 that transforms the received imaging signals into projected images. The projected images are reflected onto a plurality of first surface convex mirrors 90,100,110 that are individually associated with the respective video imaging units 60,70,80. The projected images reflected from each of the mirrors 90,100,110 are then incident upon a panoramic screen 120, such that the projected images from each of the projection units 60,70,80 are synchronized with each other to form a complete and seamless image. Moreover, because the radius of curvature of the mirrors 90,100,110 matches the radius of the curvature of the panoramic screen 120, the projected image is displayed free or nearly free of distortion.

Also coupled to the image rendering system 20 is the interface 40 that maintains various control systems, interactive displays, and other components that coact to provide an immersive and realistic virtual environment that the user of the system 10 may use to interact with the simulation software. In one aspect, the interface system 40 may include a mock-up cockpit 130 positioned with regard to the screen 120 so as to allow the user to interact in a highly realistic manner with the components provided by the interface system 40. As such, the system 10 provides a highly immersive and realistic virtual environment in which the user of the system 10 is able to interact.

While the following discussion relates to the system 10 being configured as a flight simulator, such should not be construed as limiting as the system 10 may be configured to simulate other activities, such as driving for example. As shown in FIGS. 1A-B, the image rendering system 20 generally comprises an Ethernet based computer network that maintains the primary computer 50 and a network switch 200 coupled thereto. The primary computer 50 may comprise any general purpose computer that is configured to execute various simulation software, such as flight simulation software. For example, the primary computer 50 may be configured to execute flight simulation software provided under the trademark X-PLANE®, although any suitable flight simulation software may be utilized. It should be appreciated that the simulation software may be configured so that the system 10 may simulate any desired aircraft, and any desired geo-spatial terrain and aerial environments in which the simulated aircraft may interact in response to inputs generated by the user of the system 10.

The network switch 200 provides dedicated bandwidth to each component coupled thereto, and also provides full-duplex communication (simultaneous transmission and reception) between each of the various components coupled to the switch 200. Such features provided by the network switch 200 are advantageous as it allows for faster screen redraw or rescanning of the projected images that are displayed upon the panoramic screen 120, thus reducing the amount of perceptible artifacts shown. A wired or wireless Internet network access point or interface 202 coupled to the network switch 200 allows the pilot or flight student in the cockpit 130 to communicate with remote air traffic controllers (ATC). In addition, the Internet access point 202 allows the simulated aircraft generated by the system 10 to interact with a plurality of other simulated aircraft that are being simulated on compatible remote simulation systems. As such, the network switch 200 allows for the communication of various signals between the projection system 30, the interface system 40, the wired or wireless Internet access point 202, and an instructor station 210 all of which will be discussed in more detail below.

The interface system 40 provides the cockpit 130, such as that shown in FIG. 2, as a suitable mock-up structure that accurately and realistically mimics that of an actual aircraft. Within the cockpit 130, various instrumentation and controls may be mounted and arranged in a realistic and accurate manner. Specifically, the cockpit 130 provides a physical representation of the actual aircraft or other apparatus that is to be used in association with the simulation software being used by the system 10. Thus, if the virtual reality simulator 10 is being used for the simulation of a helicopter for example, then the cockpit 130 is physically configured with the controls, gauges, and other instrumentation arranged in the same manner as they would be in an actual helicopter so as to provide the “look and feel” of a real aircraft.

Associated with the cockpit 130 is a cockpit display 250 that is coupled to the primary computer 50 via an active video display splitter 252. Specifically, the cockpit display 250 may comprise any suitable flat panel display, such as an LCD (liquid crystal display) for example. As such, the cockpit display 250 is configured to graphically render various gauges, controls, and instrumentation that are associated with the particular simulation software being executed at the primary computer 50. Particularly, the cockpit display 250 may show any desired gauges, controls and instruments, such as, in the case of a flight simulator, an altimeter, and artificial horizon for example. To allow the user of the system 10 to interact with the graphically rendered gauges, controls, and instrumentation a touch sensitive input panel 260 is provided by the cockpit 130. The input panel 260 is coupled to the primary computer 50, and provides a transparent input surface that is configured to recognize a user's touch. In use, the transparent input surface of the input panel 260 is disposed upon the screen of the cockpit display 250. As such, the graphically rendered gauges, controls, and instrumentation displayed by the cockpit display 250 are shown through the transparent input surface. Thus, touching the area of the input surface that is associated with the graphically rendered gauges, controls, and instrumentation shown on the cockpit display 250 results in an associated function being carried out by simulation software executed by the primary computer 50. It should also be appreciated that the cockpit display 250 and the touch sensitive input panel 260 may be integrated as a single unit. In addition, the cockpit 130 may also provide one or more auxiliary cockpit display screens 270 that are coupled to the primary computer 50 via the active video display splitter 252. The auxiliary cockpit display screens 270 are configured to display the same graphically rendered gauges, controls, and instrumentation that are shown by the cockpit display 250 previously discussed. As such, the auxiliary cockpit display screens 270 may be placed outside the cockpit 130 so that individuals not participating in the simulation may view what the pilot or flight student is viewing with respect to the status of the gauges, controls, and instrumentation shown on the cockpit display 250.

In addition to the graphically rendered gauges, controls and instrumentation displayed by the cockpit display 250, the cockpit 130 also provides various digital and analog inputs and outputs (I/O) 290, 292 that are interfaced with the primary computer 50. For example, the digital I/O 290 may comprise various inputs, such as hardware switches, buttons, and other digital instrumentation and avionics that are configured with a designated function that is invoked by the simulation software when the input is actuated. In addition, the digital I/O 290 may also provide various digital outputs such as LEDs (light emitting diodes) and audio alarms that are used to indicate various conditions of the simulated aircraft. With regard to the analog I/O 292, it may comprise various inputs, such as a control stick 294, and rudder pedals 296,298, as shown in FIG. 2, that are commonly used to navigate an actual aircraft, as well as any other analog control utilized by the system 10. In addition, the analog I/O 292 may also provide various analog outputs, such as dimmable cockpit lighting for example. As such, the digital and analog I/O 290,292 provide interactive inputs and outputs that accurately and realistically represent that found in an actual aircraft, and which serve to allow the user to control the movement and operating conditions of the simulated aircraft.

The cockpit 130 also includes a GPS (Global Positioning System) interface 300 which is configured to allow a user of the simulator 10 to selectively attach various panel mounted or portable avionic GPS navigation/communication units, as would be used in an actual aircraft, to the primary computer 50. It is known that avionic GPS units provide various navigation and communication functions used in flight. By attaching an actual avionic GPS unit to the interface 300, the GPS unit is able to utilize the positional data, such as longitude and latitude coordinates, generated by the simulation software, to generate various navigational data for use by the flight student or pilot. For example, the navigational data generated by the GPS unit may provide altitude, ground speed, and air speed, and may provide mapping functions that provide various information, such as restricted areas, and airport location that are used by the flight student or pilot to navigate the simulated aircraft. Thus, because the GPS unit utilizes positional data determined by the flight simulation software, the navigational data generated therefrom by the GPS unit is highly accurate, thus providing the flight student or pilot with realistic navigational information. As such, the use of an actual GPS unit in conjunction with the virtual reality simulator 10 further enhances the overall realism and immersion that is imparted to the user, such as a flight student or pilot, that is operating the simulator 10. Moreover, because various GPS units may be utilized, the cockpit 130 can be customized to utilize any particular type of avionic GPS unit that is desired.

It should also be appreciated that the FAA desires to train pilots in the use of complicated avionics systems in an environment that is safe, without endangering the flight student, pilot, property, and other individuals that may be harmed as a consequence of the actions of the flight student or pilot. As such, the virtual reality simulator 10 provides training capabilities that enable the instructor and/or flight student to carry out a highly realistic flight simulation using the same complex avionics used in an actual aircraft, while ensuring the safety of all individuals and property. In addition the virtual reality simulator also provides various training features, such as pausing the simulation, which allows the flight student and instructor to review an important point or to raise questions to enhance the learning of the flight student. As such, the virtual reality simulator 10 allows the users thereof the opportunity to learn how to control and navigate an aircraft using complex avionics systems found in an actual aircraft, but allows such learning to be conducted in a safe environment.

In addition to the cockpit display 250, the digital I/O 290 and the analog I/O 292, the cockpit 130 also provides simulated sound effects via a sound system 310 that is in communication with the simulation software maintained by the primary computer 50. The sound system 310 may be configured to provide a full spectrum of sound effects that provide a dynamic range that simulates that of an actual landing, takeoff, flight, and various other maneuvers. In one aspect, the sound system 310 may comprise a surround-sound system, such as a 5.1-type audio system that utilizes 2 front speakers, 2 rear speakers, a center speaker and a subwoofer for example. In addition, to provide the physical sensation of takeoff and landing, the cockpit 130 may also include one or more linear actuators 320 that are controlled by the primary computer 50 and powered by a power amplifier 330 coupled therebetween. The linear actuators 320 provide a vibratory force-feedback effect to the cockpit 130, which imparts to the user the physical or tactile sensations that would be experienced in an actual aircraft when it undergoes various maneuvers, such as takeoff and landing. For example, the actuators 320 may be configured to generate vibrations having a frequency in the range of 5 to 200 Hz, although any other frequency may be utilized. It should also be appreciated that the linear actuators 320 may be positioned about the cockpit 130, such as under the floor in the cockpit 130.

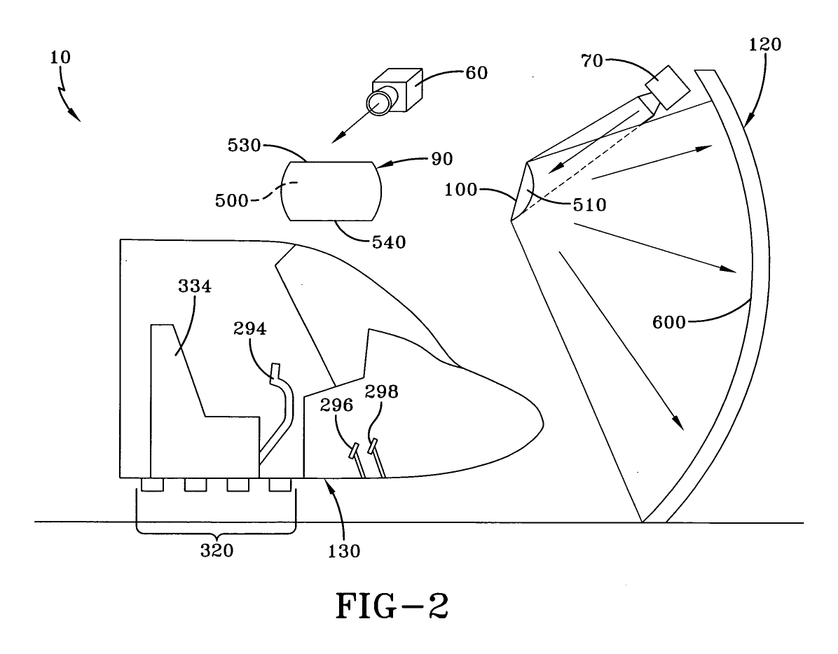

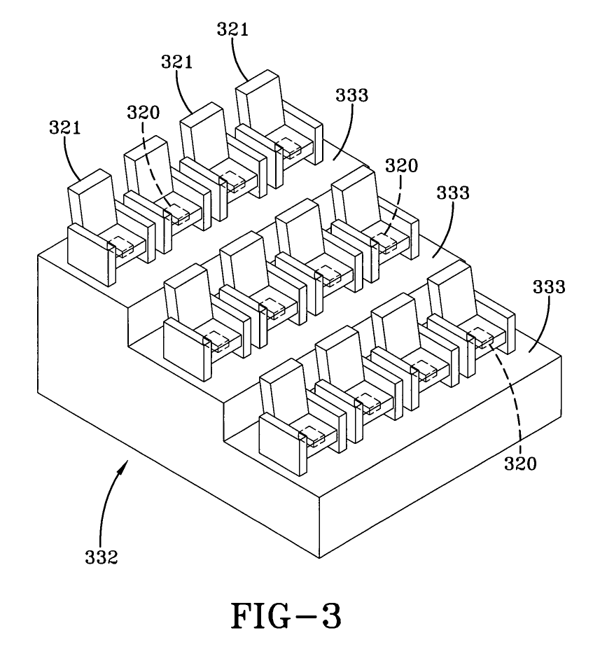

It is also contemplated that when the projection system 30 is used as part of a home entertainment system to be discussed, that the linear actuators 320 may be placed under chairs 321 that may be placed upon a multi-level riser 332 as shown in FIG. 3. The riser 332 includes one or more staggered steps 333 that allow one or more actuators 320 to be mounted. In addition, the cockpit 130 may also include an audio I/O (input/output) 336, such as a two-way headset that is coupled to an intercom 340 that is coupled to the primary computer 50. The intercom 340 and the audio I/O 336 allows the pilot or flight student to communicate with remote ATC (air traffic control) via the Internet access point 202, and allows him or her to communicate with the instructor via an audio I/O maintained at the instructor station 210 to be discussed below.

Returning to FIGS. 1A-B, the instructor station 210 is generally configured as a dedicated area that is separate from the cockpit 130, which is suitable for allowing the instructor to oversee or administer the simulation being performed. Specifically, the instructor station 210 maintains an instructor computer 350 that may comprise any suitable personal computer and associated input device, such as a mouse and keyboard that is enabled to communicate with the primary computer 50. In addition, the instructor computer 350 is coupled to one or more auxiliary instructor display screens 360, and to a primary instructor display screen 370 via an active video splitter 380. The video displays 360,370 may comprise LCD flat panel displays for example or any other type of suitable video monitor. In addition, the instructor station 210 includes an instructor instrument display screen 390 coupled to the active video display splitter 280, and an instructor center view display screen 392 that is coupled to the active video display splitter 430. The primary instructor display screen 370 presents the instructor who is administering the simulation with a map and the real-time horizontal and vertical movement (track) of the aircraft as required by the FAA, along with a control screen that allows him or her to monitor the position of the simulated aircraft, enabling him or her to change, alter, or modify various parameters, and/or variables that are permitted by the simulation software being executed via the input device. For example, the flight instructor may have control over various environmental conditions, such as wind speed, precipitation, visibility that are encountered by the flight student that is seated in the cockpit 130. Moreover, the instructor computer 350 also allows the flight instructor to control various operational subcomponents of the aircraft that are represented by the flight simulation software. For example, the flight instructor may disable the lighting in the cockpit 130, or cause a failure in one of the subsystems of the aircraft, such as the fuel system, thereby resulting in an alarm condition being indicated and resulting in a change of the aircraft's flight characteristics at the cockpit display 250 or at the digital/analog gauges 290 or controls 292, for example. In addition, the instructor instrument display screen 390 is configured to display the same set of graphically rendered gauges, controls, and instruments that are presented on the cockpit display 250. Whereas, the instructor center view display screen 392 is configured to display the same aerial and terrain images that are seen by the flight student or pilot out of the center of the simulated aircraft, which are projected by the center imaging unit 70. Thus, the instructor instrument display screen 390 and the instructor center view display screen 392 allows the instructor to have current knowledge and awareness of the navigational decisions made by the pilot or flight student. It is also contemplated that an audio I/O 396, such as a two-way headset, may be coupled to the intercom 340 so as to allow the instructor to communicate with the pilot via the audio I/O 336 maintained by the cockpit 130. Moreover, it should be appreciated that the auxiliary instructor display screens 360 may be placed outside of the instructor station 210 along with the auxiliary cockpit display screens 270. This gives persons not involved in the simulation the opportunity to view the same information as that of the instructor that is administering the simulation. Moreover, this allows instructors and students in other remote classrooms to observe a particular flight lesson being carried out at the simulator, without disturbing the instructor and student that are actively participating in the simulation.

The projection system 30 is utilized to render and realistically display video images associated with the particular simulation being performed, such as moving aerial and terrain images in the case of a flight simulation, so as to provide an immersive and interactive virtual environment that gives the user the sense of flight. It may also be appreciated that the video images may comprise both static virtual environments, as well as dynamic images, or a combination of both depending on the type of virtual environment desired. Before discussing the projection system 30 in detail, it should be appreciated that the simulation software executed on the primary computer 50 generates positional data that represents the dynamic position of the simulated aircraft as it is controlled by the pilot or flight student. Specifically, as shown in FIGS. 1A-B, this positional data is then supplied to the projection system 30, which comprises a left view computer 400, a center view computer 410, and a right view computer 420 that are each in communication with the primary computer 50 via the network switch 200. It should be appreciated that the view computers 400,410,420 may comprise general purpose computers that are each configured to execute the same simulation software that is executed on the primary computer 50. As such, the respective left imaging unit 60, center imaging unit 70, and right imaging unit 80 generate respective imaging signals that are associated with the particular simulated or virtual environment to be rendered based upon the positional information provided by the primary computer 50.

The center view computer 410 is coupled to an active video display splitter 430 that is coupled to the center imaging unit 70 and to one or more auxiliary center view display screens 450. It should be appreciated that the display screens 450 may comprise LCD flat panel monitors for example. The auxiliary center view display screens 450 are configured to display the same aerial view that is seen out of the center window of the cockpit 130, which is presented by the center imaging unit 70. As such, the auxiliary center view display screen 450, the auxiliary instructor display screen 360, and the auxiliary cockpit display screens 272 may all be placed together in a suitable arrangement for viewing by interested individuals to see how the pilot is performing during a simulation. Such a configuration is especially beneficial in the case of a public demonstration of the virtual reality simulator 10 where it is desired that the group of interested individuals is kept at a suitable distance from the cockpit 130 and instructors station 210 so as not to disturb the instructor or the pilot during the simulation.

The imaging units 60,70,80 comprise video projection systems that may utilize various projection technologies, including LCD (liquid crystal display) projection, DLP (digital light processing), any other DMD-type (digital micro-mirror devices) projection technology, as well as any other suitable video projection technology. To provide coverage across the panoramic screen 120, the raw or complete video images generated by the flight simulation software, are divided into a number of discrete image segments that are equal to the number of video imaging units that are utilized by the system 10. Each image section is associated with an imaging signal that is supplied by the primary computer 50 to the respective imaging unit 60,70,80. For example, the raw or complete video images generated by the flight simulation software may be separated into 3 image segments that are each associated with a single imaging signal. Each of the 3 imaging signals are then passed to the respective imaging units 60,70,80, via the respective view computers 400,410,420, where the imaging signals are converted to projected images that are projected upon the screen 120 so as to form a complete and seamless image. Thus, because multiple imaging units 60,70,80 are used to render a single complete image from a plurality of projected video segments displayed upon the panoramic screen 120, the virtual reality simulator 10 may utilize connection wires that are used to couple the network switch 200 to the view computers 400,410,420 that are equal in length. In addition the connection wires that are used to couple each of the view computers 400,410,420 to each of the respective imaging units 60,70,80 may also be made equal in length. The use of equal length connection wires is a generally known technique that ensures that projected images from each of the imaging units 60,70,80 are synchronized with each other. This allows the projection system 30 to provide a complete and seamless image, while reducing the occurrence of various video artifacts, including jitter and/or tearing at the seams between each of the projected images. In addition to matching the length of the connection wires discussed above, a “master clock” may be utilized to further provide proper synchronization between each of the view computers 400,410,420.

In another aspect of the present invention 10, it is also contemplated that the panoramic screen 120, mirrors 90,100,110, and imaging units 60,70,80 may be replaced with a flexible-type LCD (liquid crystal display) screen. This configuration allows the virtual reality simulator 10 to be implemented in areas where space is constrained, or where only a single-seat aircraft is being simulated, but an immersive and realistic simulation environment is desired. To utilize the flexible-type LCD screen for use by the virtual reality simulator 10, it is curved or flexed to form a concave imaging surface upon which the images generated from the simulation software are shown. For example, the flexible-type LCD screen may be curved to from a 180-degree panoramic imaging surface enabling a realistic and immersive simulation environment to be created.

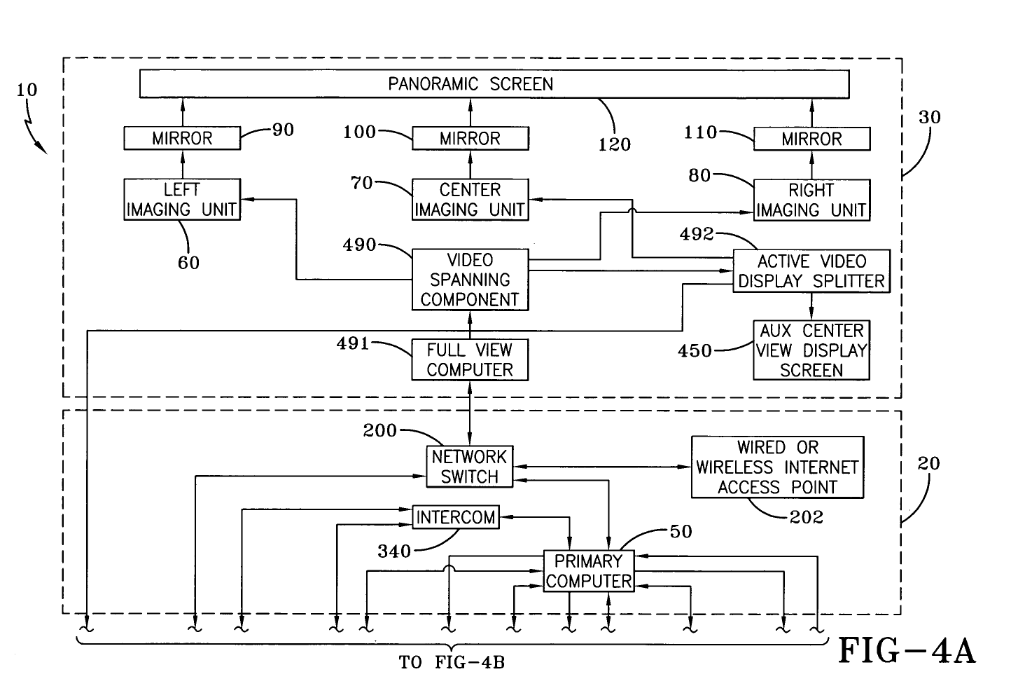

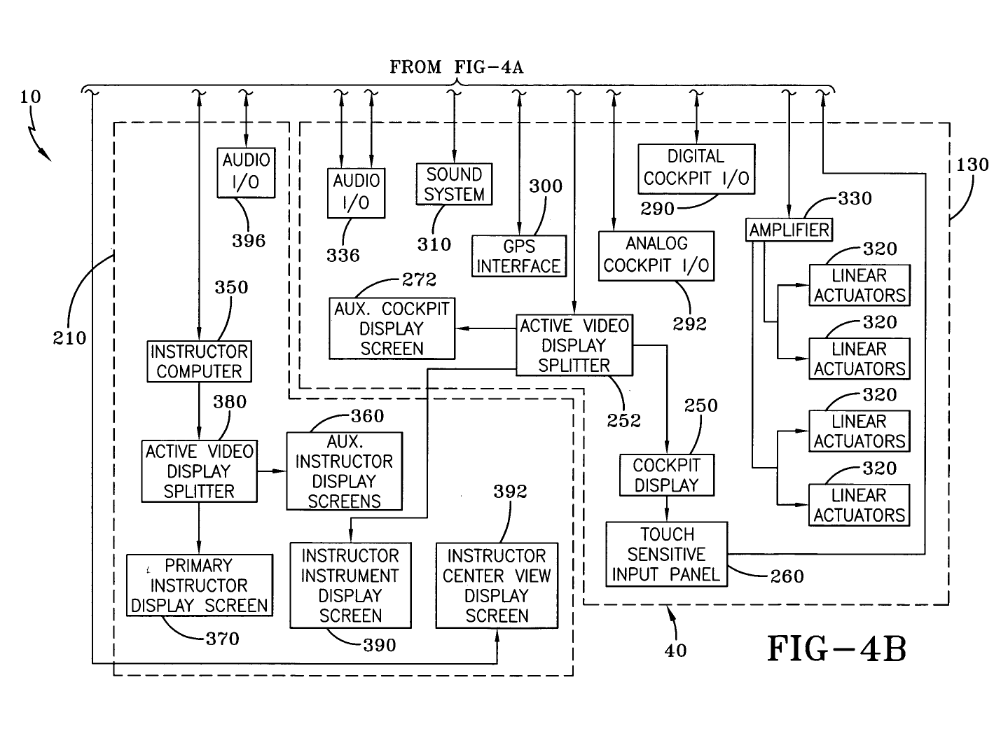

In another aspect of the virtual reality simulator 10, shown in FIGS. 4A-B, it is contemplated that the left view computer 400, the center view computer 410, and the right view computer 420 may be replaced by a video spanning component 490, such as that provided under the trademark MATROX® TRIPLEHEAD2GO, and a full view computer 491. The full view computer 491 may comprise any suitable computing system that is configured to execute the same simulation software that is executed on the primary computer 50. The video spanning component 490 is configured to alter the resolution of the complete or raw video image supplied from the simulation software provided by the full view computer 491, such that the width dimension of the complete or raw image is divided equally by the number of imaging units used. For example, because 3 imaging units 60,70,80 are used by the system 10 as shown in FIGS. 4A-B, the spanning component 490 generates three discrete images, each having a width resolution that is one third of the resolution of the complete or raw video image generated by the simulation software maintained by the full view computer 491. The right and left images are then supplied from the spanning component 490 to the respective left, and right imaging units 60,80 for projection upon the screen 120. The center imaging unit 70 is coupled to the video spanning component 490 via an active video display splitter 492, whereupon the center image is displayed upon the screen 120. In addition, the active video display splitter 492 delivers suitable video signals from the spanning component 490 to the instructor center view display screen 392 depicting the aerial view out of the center of the cockpit 130. As such, the original complete image projected by the right, left, and center imaging units 90,110,100 is shown upon the screen 120 in its native resolution as a seamless projected image. It should also be appreciated, that when the projection system 30 is used in a home entertainment or other context, that the active video display splitter 492 may be removed, and the output of the video spanning component 490 may be coupled directly to the left, right, and center imaging units 60,80,70

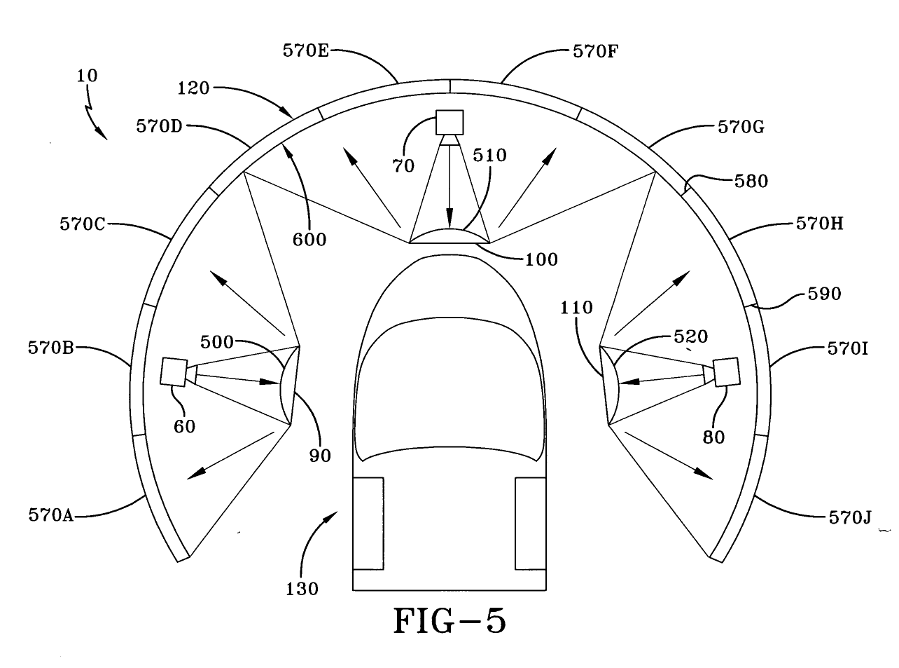

Continuing with the discussion of the projection system 30, shown in FIGS. 1A-B, 2, 4A-B, and more clearly in FIG. 5, the imaging units 60,70,80 are each configured to supply a projected image to respective mirrors 90,100,110, which is thereby reflected onto the concave portion of the hemispheric panoramic screen 120. The mirrors 90,100,110 comprise convex mirrors that have been vacuum deposited with aluminum on their respective outer reflective faces 500,510,520, as shown in FIGS. 2 and 5. In addition, it should be appreciated that each mirror 90,100,110 may be truncated so as to have straight edges 530 and 540 about its upper and lower extremities. It should be appreciated that the mirrors 90,100,110 may be formed from any suitable material, such as glass, metal, or polycarbonate for example, which can be vacuum deposited with aluminum. The use of such mirrors 90,100,110 provides high reflectivity and minimal light loss that contributes to the increased contrast and brightness of the images projected upon the screen 120. In addition, it is also contemplated that the outer reflective faces 500,510,520 may be coated with various other materials in combination with aluminum, including but not limited to silver, and silver bromide for example.

Turning to FIGS. 2, 5, and 6, the particular arrangement of the image projection units 60,70,80 and cockpit 130 with regard to the panoramic screen 120 is shown. Specifically, the panoramic screen 120 comprises a partial hemisphere that comprises about 225 degrees of horizontal curvature and about 75 degrees of vertical curvature, although other dimensions may be utilized. Such dimensions provide the user of the system 10 with an optimal field of view and depth perception for viewing the images that are displayed upon the screen 120. Moreover, the panoramic screen 120 may be attached to a support structure (not shown) so as to orient it in various positions with regard to the cockpit 130, however it is also contemplated that the panoramic screen 120 may be self-supporting, and optionally anchored to a floor or wall as desired using known techniques. In addition, to provide a projected image with high fidelity that is free or nearly free of distortion, the radius of curvature of the screen 120 is chosen to match the radius of curvature of the convex reflective faces 500,510,520 of the respective mirrors 60,70,80. Moreover, by matching the radius of curvature of the mirrors 60,70,80 with that of the panoramic screen 120 facilitates the ability of the system 10 to match each of the image segments at their seams, so as to provide a complete, seamless image. As shown in FIG. 5, the imaging units 60,70,80 are supported above the cockpit 130 via a suitable mounting system and arranged such that each unit 60,70,80 is radially spaced from the other by approximately 75 degrees so that the projected images completely cover the screen 120. However, it should be appreciated that any other suitable angle may be utilized so as to provide desired coverage of the screen 120.

The hemispherical panoramic screen 120, as shown in FIG. 5 is suitably sized with regard to the cockpit 130 so as to provide a field of view that serves to visually immerse the user into the simulation being performed. In addition, the screen 120 is formed as a plurality of fiberglass sections 570A-J. Although the screen 120 is shown as 10 sections, it should be appreciated that the screen 120 may be formed from any number of sections. The sections 570A-J, as shown in FIG. 7, maintain a chamfered edge 580,590 along their lateral edges, and disposed upon the front of the imaging surface, which is discussed below. To form the complete panoramic screen 120, the screen sections 570A-J are abutted along their chamfered edges 580,590, such that the adjacent chamfered edges form a joint (not shown). Next, an adhesive is disposed within the channel, and a section of fiberglass roving is disposed across the joint so as to join adjacent sections 570A-J together so as to form the complete panoramic screen 120. By providing the chamfered edges 580,590 on each of the sections 570A-J imparts a degree of flexibility to the panoramic screen 120 allowing it to withstand various physical (e.g. vibrations) or environmental (e.g. temperature fluctuations) forces it may encounter during its setup and use. Additionally, to form an imaging surface 600 upon which projected images from the imaging units 60,70,80 are displayed, the concave portion of the hemispheric screen 120 is initially treated with a polyester compatible surfacing primer. After priming the imaging surface 600, an elasto-polymer paint, or bright matte white epoxy is applied in multiple coats to the imaging surface 600 of the screen 120. It should also be appreciated that because the screen 120 comprises a plurality of portable sections 570 that it may be readily transported and at any desired location.

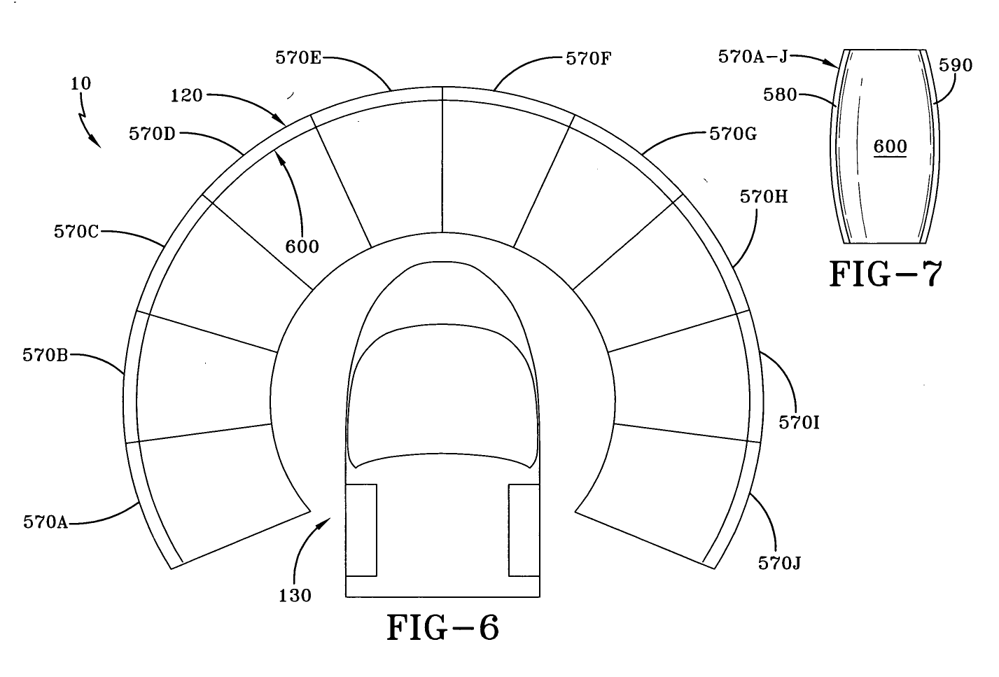

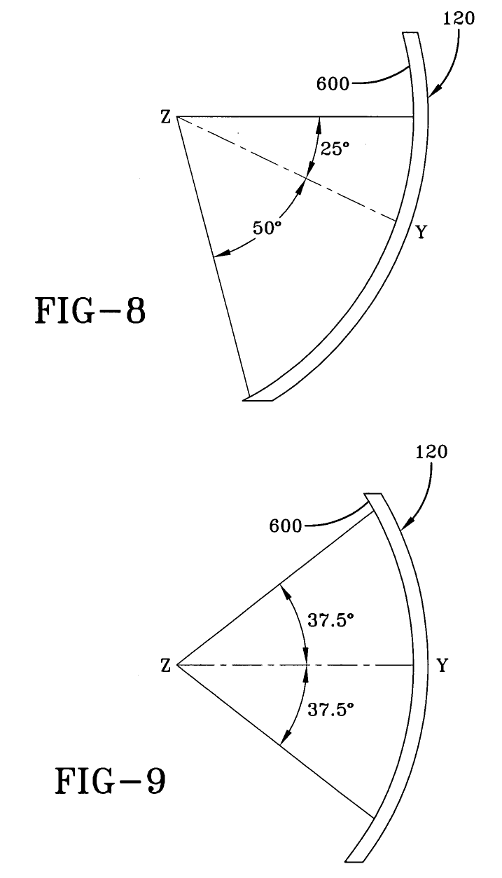

Referring to FIGS. 8 and 9, to provide the appropriate field of view needed for the particular type of simulation being provided by the virtual reality simulator 10, the vertical midpoint, denoted as Y, of the screen 120 may be positioned in a variety of orientations with respect to the user's eye level, denoted as Z. For example, in the case of helicopter and fixed-wing aircraft flight simulation, the screen 120 may be positioned so that the eye level Z of the user is about 25 degrees above the vertical midpoint Y of the screen 120, as shown in FIG. 8. As such, the screen 120 provides about 25 degrees of up view and about 50 degrees of down view. In the case of helicopter flight simulation, this particular arrangement allows the user to see a sufficient amount of ground terrain projected upon the screen 120, as would be seen in an actual helicopter. In addition, because the configuration shown in FIG. 8 enables a flight student or pilot to have the full ground view that would be provided in an actual helicopter, the simulator 10 allows the user to engage in pinnacle landings, such as rooftop landings, which are required by FAA approved simulators. Alternatively, when the virtual reality simulator 10 is used in the simulation of a military fighter aircraft, the screen 120 may be reoriented so that the user's eye level Z is below the vertical midpoint Y of the screen 120. Such a configuration provides the flight student with a greater view of the sky as is found in a typical fighter aircraft.

While the virtual reality simulator 10 may be used for the realistic simulation of various aircraft as discussed above, it should be appreciated that the projection system 30 may be utilized alone in the video entertainment context, without the use of the interface system 40 whereby the image rendering system 20 may be replaced by a suitable video source, such as a television tuner, or DVD (digital video disk) component, or gaming console or system for example. In such a case, where a viewer is sitting in his living room, the screen 120 may be configured so that the eye level of the viewer Z is at the same level as the vertical midpoint Y of the screen, as shown in FIG. 9. Such an arrangement provides the viewer with approximately 37.5 degrees of up view and 37.5 degrees of down view of the screen 120. Alternatively, if the viewer elects to stand up, when playing video games for example, it is contemplated that the screen 120 may be configured so that the eye level Z of the viewer is aligned above or below the vertical midpoint Y of the screen 120 as needed to obtain the optimum field of view for the game being played.

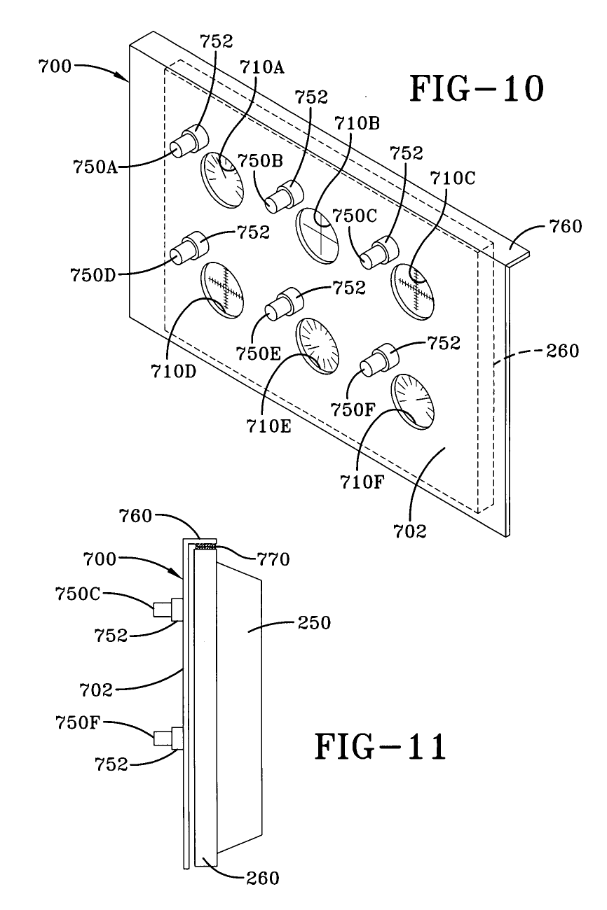

To further increase the level of realism and immersion provided by the virtual reality simulator 10, it is contemplated that a display overlay 700 for use with the cockpit display 250 may be utilized, as shown in FIGS. 10 and 11. Before discussing the particular aspects of the display overlay 250, it should be appreciated that the FAA requires that the fit, feel, and function of the simulated aircraft provide the student or pilot a highly accurate representation of an actual aircraft. As such, the display overlay 700, as well as the other aspects of the virtual reality simulator 10 discussed herein contribute to the achievement of the FAA's goal by providing controls and other avionic instrumentation in an arrangement that accurately replicates that of an actual aircraft.

The panel overlay 700 comprises a panel 702 that maintains a plurality of apertures 710A-F that are arranged and shaped to correspond to the layout of the graphically rendered controls, gauges, and instruments displayed on the cockpit display 250 previously discussed. As such, when the display overlay 700 is placed upon the touch sensitive input panel 260 and the cockpit display 250, the apertures 710A-F allow the graphically rendered controls and gauges to show through, giving a more realistic appearance thereto. In addition, the display overlay 700 may also include one or more controls 750A-F that are attached thereto via vacuum formed housings 752. It should also be appreciated that the controls 750A-F may comprise various optical encoders, momentary push-buttons, or any other desired switching mechanism that is used to replicate that of an actual aircraft. The controls 750A-F are supported within the housings 752, and are configured to control various functions provided by the simulation software executed by the primary computer 50. The display overlay 700 may be formed from plastic or any other suitable material, using a vacuum forming process, but such is not required. In addition, the display overlay 700 provides a retention lip 760 that allows the display overlay 700 to be selectively attached to the touch sensitive input panel 260 and/or the cockpit display 250. In addition, the use of a releasable attachment means 770, such as VELCRO® for example, that is disposed between the lip and the outer surface of the panel overlay 700 may be used to provide additional support thereto. By making the panel overlay 700 removable, a variety of panel overlays may be created that include apertures 720 and controls 750 that are associated with the specific arrangement and configuration of the instrumentation corresponding to the particular aircraft being simulated. As such, various panel overlays may be easily interchanged as needed for the particular simulation being executed.

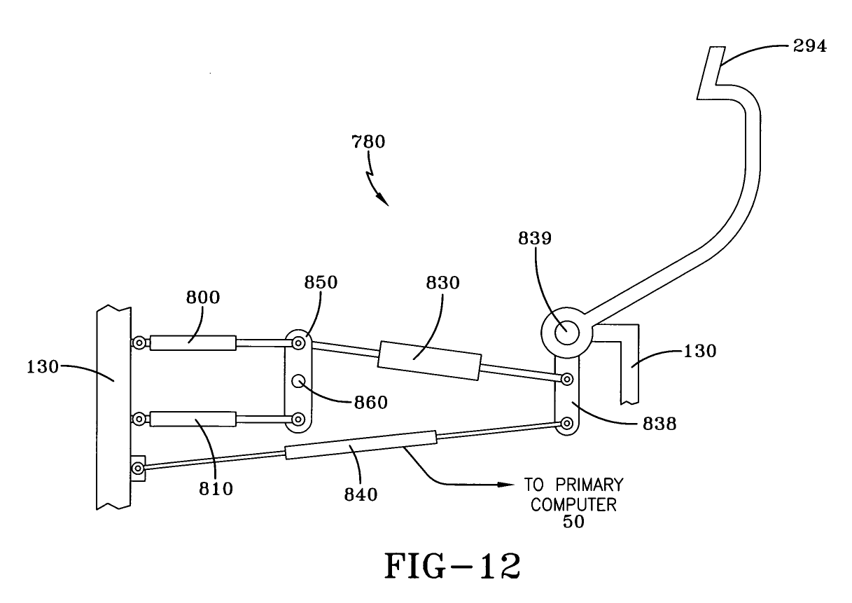

Another aspect of the virtual reality simulator 10 contemplates that the analog control stick 294 may be configured to impart an accurate tactile feel or dampening to the user when it is actuated. To enhance the “feel” or to give a more accurate amount of feedback to the user when he or she actuates the control stick 294, a feed back system 780 comprising first and second gas-charged struts 800 and 810 may be utilized, as shown in FIG. 12. The gas struts 800,810 provide a suitable amount of dampening to the user's movement of the control stick 294, which gives the user an amount of feedback or force that is equivalent or nearly equivalent to that provided by the control stick provided by an actual aircraft. It should be appreciated that the gas struts 800,810 may utilize different pressures selected to further enhance the amount of feedback imparted to the user. Moreover, the gas struts 800,810 establish an accurate neutral position for the control stick 294 that is equivalent or nearly equivalent to that of an actual aircraft. In addition, to further refine its position, a motorized turnbuckle 830 may be utilized to trim the position of the control stick 294.

It is contemplated that the feedback system 780 includes a linear precision potentiometer 840, which is used to communicate the position of the control stick 294 via various voltage levels to the primary computer 50, and to provide enhanced smoothness and consistent positional indication of the control stick 294, while also providing increased durability and accuracy. In terms of construction of the feedback system 780, the control stick 294 is pivotally attached to the frame of the cockpit 130 via an arm 838 that is pivotally coupled to a pivot 839. The arm 838 is coupled to one end of the turnbuckle 830, while the other end of the turnbuckle 830 is coupled to a pivot arm 850 that is configured to rotate about a pivot 860. Coupled between the pivot arm 850 and the frame of the cockpit 130 are the first and second gas struts 800,810. Additionally, the potentiometer 840 is coupled between the arm 838 and the frame of the cockpit 130 as well. As such, when the control stick 294 is moved to control the simulated aircraft, the gas struts 800,810 impart equal pressure in the various movements of the control stick 294 providing realistic amounts of dampening or feedback to the user. It should be appreciated that in addition to the feedback system 780 shown in FIG. 12, which is used to control the pitch of the simulated aircraft, another feedback system 780 may be suitably linked to the control stick 294 using known techniques to control the roll of the simulated aircraft. In addition, the feedback system 780 may also be suitably coupled using known techniques to the rudder pedals 296 and 298 to control the yaw of the simulated aircraft.

Although the previous discussion of the virtual reality simulator 10 has been directed to simulators, such as flight simulators, such should not be construed as limiting, as the present invention 10 may be utilized and readily adapted for use in a variety of other non-simulation contexts, such as videoconferencing. For example, by replacing the cockpit 130 with a conference table and providing a plurality of video cameras, a virtual conferencing system may be formed. The video cameras may be arranged so that they provide suitable coverage of the persons seated about the table, and the video signals associated therewith are delivered to each of the imaging units 60,70,80 for display on the panoramic screen 120 in the manner discussed.

It is also contemplated that the system 10 may be utilized in a recreational fitness context, whereby the cockpit 130 may be replaced by a treadmill, or other exercise apparatus, or even may consist solely of an open space for one to simply run or exercise in place. As such, the projection system 30 may be configured to project highly realistic images upon screen 120 so as to allow the user to interact with the virtual environment while exercising.

Based upon the foregoing, one advantage of the present invention is that a video projection system for a virtual reality simulator provides a plurality of imaging units for projecting realistic video images upon a panoramic screen. Another advantage of the present invention is that the projected images generated from the imaging units are reflected off convex first surface mirrors and onto the panoramic screen so as to provide a seamless image. Yet another advantage of the present invention is that the panoramic screen is hemispherical, so as to provide a large field of view for the user of a virtual reality simulator. Still another advantage of the present invention is that the radius of curvature of the convex first surface mirrors is equal to the radius of curvature of the hemispherical panoramic screen so as to provide a distortion free or nearly distortion free image. Another advantage of the present invention is that a display overlay may be used upon a touch screen display to provide a highly realistic instrumentation. In addition, another advantage of the present invention is that a plurality of gas-charged struts are utilized to give positive feedback to the movement of a control stick. Furthermore, an advantage of the present invention is that a flexible-type LCD screen may be used to provide a realistic and immersive environment for simulating an activity in areas where space is constrained.

Thus, it can be seen that the objects of the invention have been satisfied by the structure and its method for use presented above. While in accordance with Patent Statutes, only the best mode and preferred embodiment has been presented and described in detail, it is to be understood that the invention is not limited thereto and thereby. Accordingly, for an appreciation of the true scope and breadth of the invention, reference should be made to the following claims.

What is claimed is:

1. A virtual reality simulator, comprising:
a plurality of spaced imaging units that are configured to receive imaging signals that are each associated with a discrete segment of a complete image, said imaging units configured to project a projection image that comprises said imaging signal;
a plurality of first surface mirrors configured with a convex reflective face configured to reflect said projection images from each said respective imaging units; and
a screen having an imaging surface configured to receive said projection images reflected from said mirrors, so as to display said complete image.

2. The virtual reality simulator of claim 1, wherein said imaging units are radially spaced from each other by about 75 degrees.

3. The virtual reality simulator of claim 1, wherein said reflective face of said first surface mirrors comprises vacuum deposited aluminum.

4. The virtual reality simulator of claim 1, wherein said first surface mirrors are truncated to form horizontally oriented edges.

5. The virtual reality simulator of claim 1, wherein said imaging surface of said screen comprises a concave hemispheric surface.

6. The virtual reality simulator of claim 5, wherein said screen is panoramic.

7. The virtual reality simulator of claim 6, wherein said panoramic screen has about 225 degrees of horizontal curvature.

8. The virtual reality simulator of claim 7, wherein said panoramic screen has about 75 degrees of vertical curvature.

9. The virtual reality simulator of claim 5, wherein the radius of curvature of said reflective face of said mirrors is about the same as the radius of curvature of said imaging surface of said panoramic screen.

10. The virtual reality simulator of claim 1, wherein said screen comprises a plurality of sections that are configured to be removably attached together.

11. The virtual reality simulator of claim 10, wherein each said section is chamfered along its lateral edges.

12. The virtual reality simulator of claim 1, wherein said imaging surface comprises a white matte finish.

13. The virtual reality simulator of claim 1, further comprising an image rendering system that includes a primary computer configured to provide positional data to said imaging units, wherein said projection images generated by said projection units are based on said positional data.

14. The virtual reality simulator of claim 13, wherein said primary computer communicates with said imaging units via a network switch.

15. The virtual reality simulator of claim 14, further comprising an interface system coupled to said network switch, said interface system configured to allow a user to alter the positional data provided by the primary computer to thereby alter the projected images generated by said imaging units.

16. The virtual reality simulator of claim 13, wherein said interface system includes one or more actuators that are controlled by said primary computer.

17. The virtual reality simulator of claim 16, wherein said actuators generate a frequency that is between 5 to 200 hertz.

18. A feedback system for a virtual reality simulator comprising:
a frame structure maintained by the virtual reality simulator;
a control stick pivotally mounted to said frame structure, said control stick carrying an arm;
a pivot arm pivotally mounted to said frame structure;
an adjustable turnbuckle pivotally mounted between said arm and said pivot arm; and
a pair of struts pivotally mounted between said pivot arm and said frame;
wherein the movement of the control stick is dampened by the operation of said struts.

19. The feedback system of claim 18, further comprising a precision potentiometer mounted between said pivot arm and said frame structure, whereby the movements of said control stick cause said potentiometer to output an associated electrical level.

20. An apparatus for a virtual reality simulator comprising:
a touch sensitive display having an imaging surface for displaying one or more user selectable images for controlling the virtual reality simulator;
a panel configured to cover said imaging surface, said panel comprising:
a plurality of apertures configured to be aligned with said images shown on said imaging surface; and
at least one housing to maintain a control, said control configured to control said virtual reality simulator.

21. A virtual reality simulator comprising:
a projection system including:
a plurality of spaced imaging units;
a video spanning component coupled to said imaging units, said spanning component configured to receive imaging signals that are associated with a complete image, said spanning component configured to divide the width dimension of said complete image into a number of image segments equal to the number of said imaging units, wherein each said imaging units generates a projection image of each said image segments;
a plurality of first surface mirrors configured with a convex reflective face configured to reflect said projection images from each said respective imaging units; and
a screen having an imaging surface configured to receive each of said projection images reflected from said mirrors, so as to display said complete image.

22. A virtual reality simulator comprising:
a flexible-type display;
a primary computer adapted to execute simulation software, said primary computer delivering simulation images based on said simulation software to said display; and
an interface system coupled to said primary computer, said interface system enabling a user to interact with said simulation software, and wherein said display is arranged with respect to said interface system to provide about 180 degrees of viewing area.
